(19) United States
(12) Patent Application Publication
(10) Pub. No.: US 2005/0142519 A1
(43) Pub. Date: Jun. 30, 2005

(54) Device allowing careful dental prevention and hygiene

(76) Inventor: Gian Luca Atzori, Sorso (IT)

Correspondence Address: COLLARD & ROE, P.C., 1077 Northern Boulevard, Roslyn, NY, 11576-1696, US

(21) Appl. No.: 10/988,001

(22) Filed: Nov. 12, 2004

Related U.S. Application Data
(63) Continuation-in-part of application No. PCT/EP03/05024, filed on May 14, 2003.

(30) Foreign Application Priority Data
May 15, 2002 (IT) SS2002A000003

(51) Int. Cl. A61C 15/00; A61C 17/00; A61C 3/00

(52) U.S. Cl. 433/216; 433/141

(57) ABSTRACT

A handle-free device is described which allows careful dental prevention and hygiene and which comprises a supporting frame (made of latex or other soft material) at one end of which there is a cavity whilst at the other end there is a ring. Bristles are applied to the part of the frame where the cavity is present, preferably borne by a base body inserted in the framework; advantageously, the base body also holds a capsule containing an oral hygiene product. In the use, the user inserts two fingers of the same hand into the cavity and the ring; preferably the user inserts the index finger into the cavity and the thumb from the same hand into the ring.

### BACKGROUND OF THE INVENTION

1. Field Of The Invention

The invention concerns a handle free device which allows careful dental prevention-and hygiene of every part of the oral cavity, even if difficult to reach with traditional tooth brushes.

2. Description Of The Prior Art

Cleaning ones teeth, even several times a day is becoming a more widespread habit, which is conditioned however by multiple factors, amongst which the fact that (outside of ones own home) it is not always possible to have a toothbrush and/or toothpaste, etc. available.

Furthermore traditional type tooth brushes do not allow easy reach to all corners of the oral cavity.

The aim of the present invention is to create a device suitable to improve the prevention of oral diseases and dental hygiene, obviating the above mentioned inconveniences and/or limitations.

Besides allowing correct oral hygiene even outside of ones own home, the subject device of the present invention has the following distinguishing characteristics: ease of use, disposable, portable (it can even be stored inside a wallet), elasticity (which allows easy holding even in the absence of a handle), the presence of a capsule (or dispenser) to distribute the tooth paste.

In addition, the ergonomic shape makes it a high clinical and physiological quality accessory, as well as a professional oral hygiene support.

### SUMMARY OF THE INVENTION.

The subject of the present invention is a device suitable for allowing careful dental prevention and hygiene, comprising a supporting framework, at one end of which a cavity is present, whilst at the other end a ring is present.

The cavity and the ring are suited to hold two fingers of the same user's hand preferably the cavity holds the user's index finger whilst the ring holds the thumb of the same hand.

Bristles can be applied to the area of the frame defining the cavity.

It is a particular subject of the present invention a device without handle suitable for allowing careful dental prevention and hygiene, comprising a supporting frame, said supporting frame comprising a first end and a second end, said first end comprising: a cavity suitable for receiving one of the user's fingers and an area suitable for scrubbing and cleaning the teeth and/or gums of the user, said second end being suitable for receiving another finger of the same hand of the user, wherein said second end is integral with said first end in the supporting frame and comprises a ring suitable for receiving another finger of the same hand of the user so that the device can be safely and firmly held on said user's hand during use by means of the elastic tension grip determined by the extension of said two fingers. Further advantages will appear more evident, to the man skilled in the art, from the following detailed description of some example preferred embodiments non limiting in nature and shown in the enclosed Figures.

### BRIEF DESCRIPTION OF THE DRAWINGS

FIG. 1 shows schematically a side view of a first embodiment of a device for dental prevention and hygiene according to the present invention;

FIG. 2 shows schematically the use on a hand of a second embodiment of a device for dental prevention and hygiene according to the present invention;

FIG. 3 shows schematically the use on a hand of a third embodiment of a device for dental prevention and hygiene according to the present invention.

### DESCRIPTION OF THE PREFERRED EMBODIMENT

The invention will now be better described with reference to some non limiting embodiments shown in the enclosed figures, from which it may be seen that such device is without a handle and comprises a supporting frame 1 realised in a (very) soft and elastic plastic material (preferably latex or other functionally equivalent material): at one end of the frame 1 is located a cavity 2 which supports the active part (not shown in the attached figure) and which is suitable for receiving one of the user's fingers, whilst at the other end an adjustable or deformable ring 3 is located, integral with the supporting frame 1, suitable for receiving another finger from the same hand of the user.

In the preferred embodiment herein described the cavity 2, defined by a bag-like or pocket-like body, is suitable for receiving the user's index finger and the ring 3 is suitable for receiving the thumb, but without departing from the scope of the invention the user can insert into the cavity 2 and into the ring 3 any other two fingers of the same hand: for example the user can insert the middle finger into cavity 2 and the thumb into ring, 3 or the index finger into cavity 2 and the little finger into ring 3.

The ring 3 can be tensioned by the thumb, so as the elastic tension grip determined by the extension of the two fingers allows the user a safe and true hold which facilitates correct brushing of the teeth.

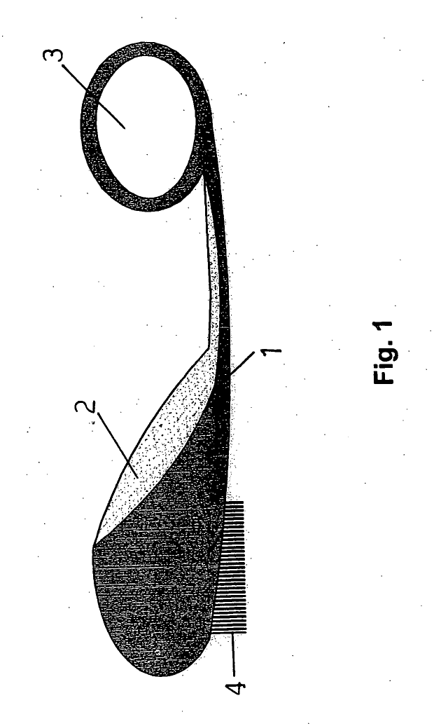

In the embodiment of FIG. 1, the active part comprises a base body which bears the bristles 4, which are therefore applied to the area of the frame 1 housing the cavity 2; preferably but not necessarily, the base body is applied to the supporting frame 1 and inserted therein.

Advantageously the active part is in addition provided with a capsule (carried on the base body) which contains toothpaste (and/or another oral hygiene product) which is activated at the time of use and allows optimal conservation of said product until its possible use; the bristles 4 set at intervals between themselves inside the base body, realised in a semi-soft material, allow harmonic and anatomical movements.

Preferably, the capsule containing the oral hygiene product is a single dose capsule.

All these features make it such that who has periodontal problems (gingivitis, phlogosis, etc.) can perform improved cleaning with minimum suffering, since the device according to the invention, guided by a user's finger (preferably the index finger), is more precise and sensitive than the classic toothbrush with a plastic handle, reaching even the least accessible parts and corners of the oral cavity, which are breeding-ground of bacterial plaque. The main feature of the present invention is having property and functionality in a single device.

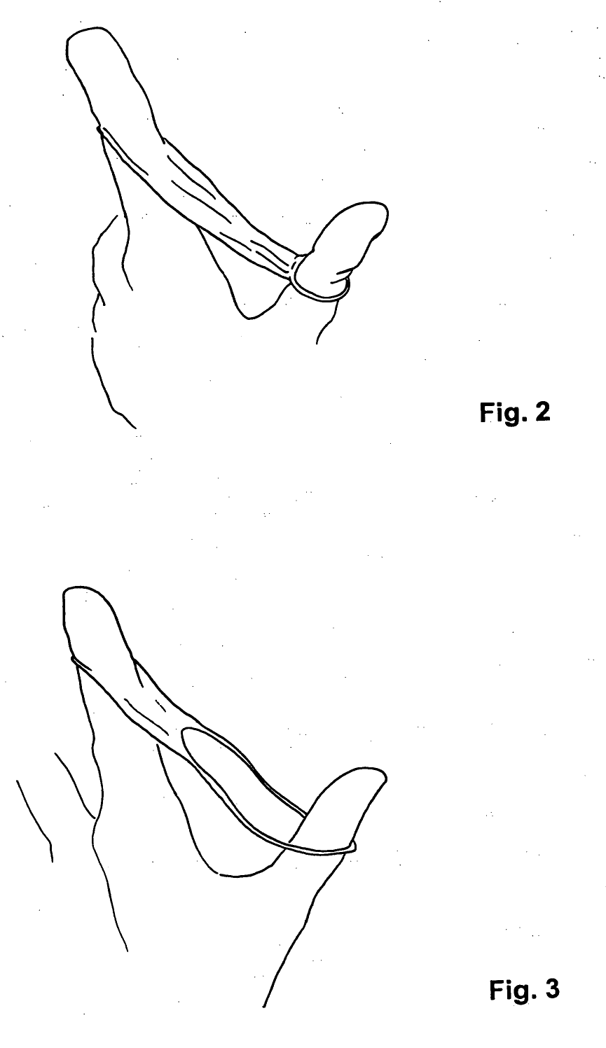

The invention described above is susceptible to several modifications and variations without departing from the scope of the present invention: for example the bristles 4 can be absent (FIGS. 2, 3); in such a case the area of the active part destined to scrub and clean the teeth, gums or other parts of the oral cavity, can be carried out as a simple surface made of latex or however of the same material of which the rest of the device is made (for example latex), or as surfaces of a different material applied onto the supporting frame (for example celluloid, polyeurethane or other plastic resins); in both cases the area of the active part destined to scrub and clean the teeth, gums or other parts of the oral cavity can be substantially smooth, appropriately corrugated or rippled (for example with ribs or elongated corrugations, with studs), covered with villae or microvillae, bumps or other protuberances suitable for scrubbing, cleaning and massaging teeth and gums; or such an area can be carried out as a buffer of spongy, felt-like material, or in the form of wads applied onto the base body, and in any case in natural or synthetic fibre (for example microfibres); microfibres can be dispersed as a filler in the elastic material of the frame 1. These and other embodiments devoid of bristles can be carried out in a manner such as to be storable in packages of very small size or of reduced thickness, which the user can comfortably carry on himself for example in a wallet; the ring 3 can be realised both as an eye having dimensions not much larger (FIGS. 1, 2), or even less than, the diameter of the user's thumb, or as an eye notably larger than the diameter of the thumb (FIG. 3).

Without departing from the scope of the present invention a man skilled in the art can make all the modifications and improvements suggested through normal experience and through the natural evolution of the art to the device described above for careful dental prevention and hygiene.

1. A device without handle suitable for allowing careful dental prevention and hygiene, comprising a supporting frame, said supporting frame comprising a first end and a second end, said first end comprising:
a cavity suitable for receiving one of the user's fingers and
an area suitable for scrubbing and cleaning the teeth and/or gums of the user, said second end being suitable for receiving another finger of the same hand of the user,
wherein said second end is integral with said first end in the supporting frame and comprises a ring suitable for receiving another finger of the same hand of the user so that the device can be safely and firmly held on said user's hand during use by means of the elastic tension grip determined by the extension of said two fingers.

2. Device according to claim 1, wherein said ring is deformable.

3. Device according to claim 1, wherein said supporting frame is made of an is elastic material, or a soft plastic material.

4. A device according to claim 1, wherein said cavity is suitable for receiving the user's index finger.

5. A device according to claim 1, wherein said cavity is suitable for receiving the user's middle finger.

6. A device according to claim 1, wherein said ring is suitable for receiving the thumb of the same hand of the user.

7. A device according to claim 1, wherein bristles, or sponge, natural or synthetic fibre felt, microfibre buffer suitable for scrubbing and cleaning the teeth and/or gums of the user are applied or obtained in an area of said frame where said cavity is present.

8. A device according to claim 1, wherein villae or microvillae, ripples, studs, ribs, bumps suited to scrub and clean the teeth and/or gums of the user are carved or obtained in an area of said frame where said cavity is present.

9. A device according to claim 7, wherein said bristles are supported on a base body suitable for being applied to the supporting frame and inserted therein.

10. A device according to claim 9, wherein said base body carries in addition a capsule containing an oral hygiene product.

11. A device according to claim 10, wherein said capsule containing an oral hygiene product is a single dose capsule.
